(19) United States
(12) Patent Application Publication
(10) Pub. No.: US 2015/0041294 A1
(43) Pub. Date: Feb. 12, 2015

(54) MULTI-INSTRUCTION SWITCH FOR ENHANCING ELECTRICAL INSULATION

(71) Applicant: ZIPPY TECHNOLOGY CORP., New Taipei City (TW)

(72) Inventor: King-Long LEE, New Taipei City (TW)

(73) Assignee: ZIPPY TECHNOLOGY CORP., New Taipei City (TW)

(21) Appl. No.: 13/964,906

(22) Filed: Aug. 12, 2013

(51) Int. Cl. H01H 9/02

(52) U.S. Cl. CPC H01H 9/02
USPC 200/293

(57) ABSTRACT

A multi-instruction switch for increasing electrical insulation includes a housing, a common pin and a switching pin set. The housing has an accommodating space, a conductive elastic plate disposed in the accommodating space, and a support rack disposed in the accommodating space and comprising a limiting track. The switching pin set, penetrating through the housing to extend into the accommodating space, comprises a first pin and a second pin disposed on the support rack. The first pin comprises a contact section located in the limiting track: The second pin comprises a trigger section located in the limiting track. The limiting track has an insulation space between the trigger section and the contact section. Thus, carbon residue generated during a switching process of the multi-instruction switch is not accumulated between the contact section and the trigger section due to the insulation space.

### FIELD OF THE INVENTION

The present invention relates to a multi-instruction switch, and particularly to multi-instruction switch capable of enhancing electrical insulation.

### BACKGROUND OF THE INVENTION

Along with the miniaturization of various electronic devices, designs of electronic components correspondingly follow the miniaturization trend. FIG. 1 shows a switch element that controls an output signal. Referring to FIG. 1, a conventional switch element includes a switch housing, a′ common pin 1, an normally closed pin 2 and an normally open pm 3. The switch housing includes an accommodating space, an elastic plate 41 disposed in the accommodating space, and a support rack 42 disposed in the accommodating space. The support rack 42 has a movement track 421 for the elastic plate 41 to move therein, and an insulation block 422 disposed in the movement track 421. The common pin 1 penetrates through the switch housing to extend into the accommodating space 41 to become electrically in contact with the elastic plate 41. The normally closed pin 2 is partially embedded in the support rack 42, and extends into the movement track 421 to abut against one side of the insulation block 422. The normally open pin 3 penetrates through the switch housing and is exposed in the movement track 421 with an exposed part abutting against the opposite side of the insulation block 422 whose another side is abutted by the normally closed pin 2. When the elastic plate 41 is pressed by an external force and thus moves in the movement track 421, the elastic plate 41, from the normally closed pin 2 originally in contact with, crosses the insulation block 422 to become in contact with the normally open pin 3.

As the conductive elastic plate 41 is in contact with the normally closed pin 2 or the normally open pin 3 during up-and-down movements, a contact point is melted by an electric arc as a result of electric discharge. Thus, carbon residue is generated and scattered to the surroundings and even accumulated on the insulation block 422. With long-term accumulation, the carbon residue forms a conductive layer that connects the normally closed pin 2 to the normally open pin 3. During a high-voltage test, the normally closed pin 2 and the normally open pin 3 are set on due to the conductive layer to result in malfunction of the micro-switch thus fails to pass safety certification of higher amperage and ensure an expected product yield rate.

### SUMMARY OF THE INVENTION

Therefore the primary object of the present invention is to overcome the above issue of element malfunction of a conventional switch structure due to accumulated carbon residue.

To achieve the above object, a multi-instruction switch for enhancing electrical insulation is provided. The multi-instruction switch comprises a housing, a common pin, and a switching pin set. The housing comprises an accommodating space, a conductive elastic plate disposed in the accommodating space and capable of performing a reciprocating movement when receiving depression of a user, and a support rack disposed in the accommodating space. The conductive elastic plate comprises a normal connection section and a switching connection section. The support rack has a limiting track for the switching connection section to move therein. The common pin penetrates through the housing to extend into the accommodating space, and is normally in electrical contact with the normal connection section. The switching pin set, penetrating through the housing to extend into the accommodating space, comprises a first pin and a second pin disposed on the support rack. The first pin comprises a contact section located in the limiting track. The second pin comprises a trigger section located in the limiting track. The limiting track has an insulation space between the trigger section and the contact section.

In an embodiment, the support rack comprises a first support portion for holding the first pin, and a second support portion for holding the second pin.

In an embodiment, the first support portion comprises a first slot for embedding the first pin, and the second support portion comprises a second slot corresponding to the first slot and for embedding the second pin.

In an embodiment, the second support portion comprises an engaging slot for holding the second pin.

In an embodiment, the first pin has a connection section embedded in the first support portion and connected to the contact section.

In an embodiment, the housing is formed by a base and a cover.

In an embodiment, the housing further comprises a press member assembled with the conductive elastic plate.

In an embodiment, the press member comprises a flexible support member that is deformed when receiving the depression of a user during the reciprocating movement.

In an embodiment, the housing further comprises a restoration spring disposed in the accommodating space and accommodating around the common pin to allow the conductive elastic plate to perform reciprocating movement.

Compared to a conventional multi-instruction switch structure, the multi-instruction switch of the present invention has the features below.

In the present invention, between the contact section and the trigger section in the limiting track is an insulation space. The insulation space is capable of preventing carbon residue generated during a switching process of the conductive elastic plate from accumulating between the contact section and the trigger section, thereby effectively enhancing the electrical insulation capability of a switch element.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a partial schematic diagram of a conventional switch structure.

FIG. 2 is an exploded view of a multi-instruction switch for enhancing electrical insulation of the present invention.

FIG. 3 is exploded view of a multi-instruction switch for enhancing electrical insulation of the present invention from another viewing angle.

FIG. 4 is an exploded sectional view of a multi-instruction switch for enhancing electrical insulation of the present invention.

FIG. 5A is a sectional view of a released position along a section line 5A in FIG. 4.

FIG. 5B is a sectional view of a pressed position along a section line 5A in FIG. 4.

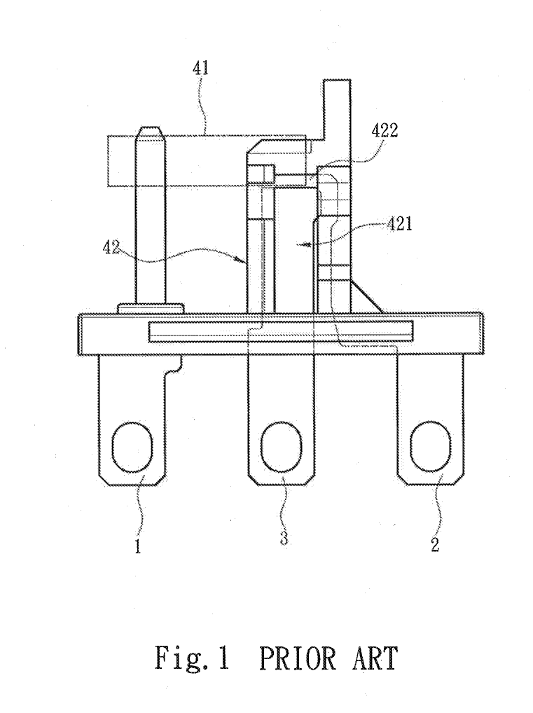

### DETAILED DESCRIPTION OF THE PREFERRED EMBODIMENTS

A multi-instruction switch for enhancing electrical insulation of the present invention can be implemented in various embodiments according to the different application requirements. Current multi-instruction switches usually comprise at least two pins for switching and outputting different instructions. In the present invention, a multi-instruction switch comprising three pin is taken as an example for explaining the embodiment, not limiting the present invention.

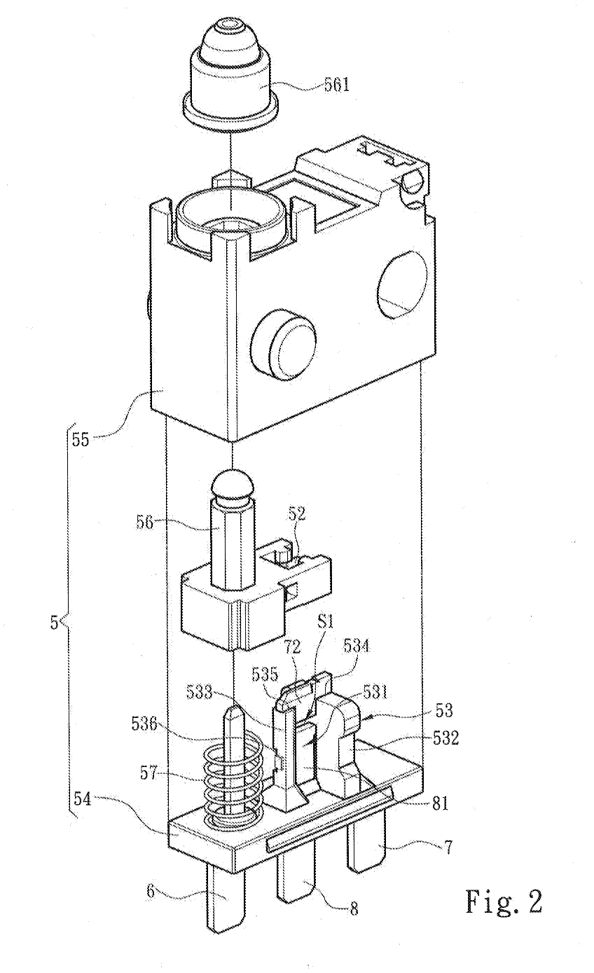

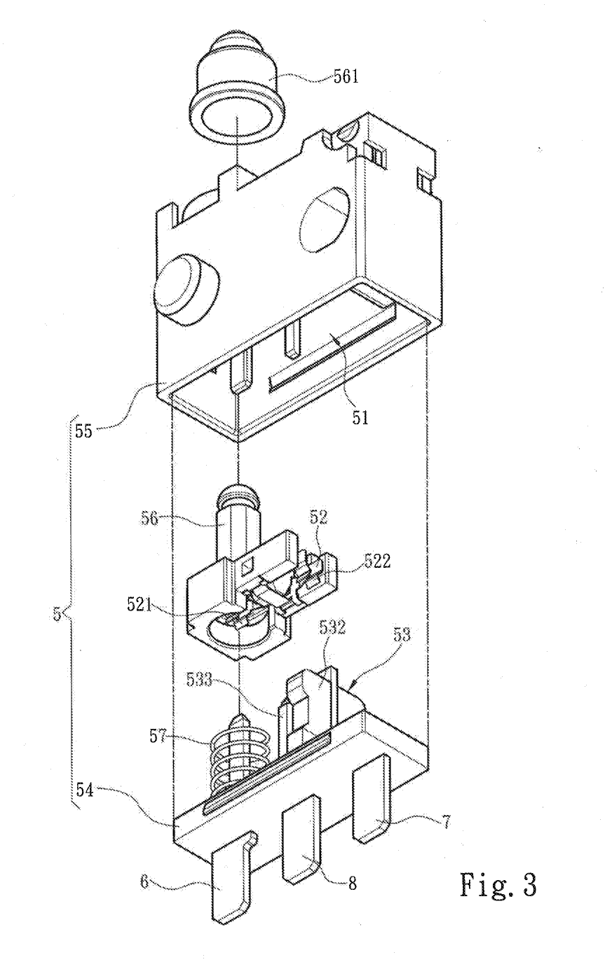

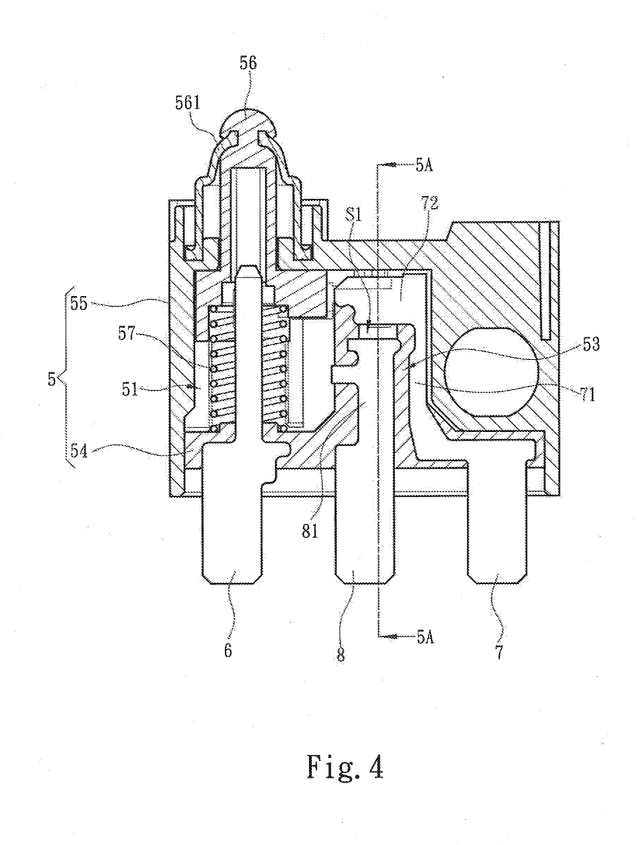

Referring to FIGS. 2 to 4, a multi-instruction switch for enhancing electrical insulation comprises a housing 5, a common pin 6, and a switching pin set having a first pin 7 and a second pin 8. The housing 5 is hollow for forming an accommodating space 51, and comprises a conductive elastic plate 52 and a support rack 53. The conductive elastic plate 52 is disposed in the accommodating space 51, and is movable when receiving an external force. The support rack 53 is connected to the housing 5 and is disposed in the accommodating space 51. More specifically, the housing 5 may be formed by assembling a base 54 and a cover 55. The conductive elastic plate 52 comprises a normal connection section 521, and a switching connection section 522 connected to the normal connection section 521. The support rack 53 extends integrally from the base 54 to the cover 55, and has a limiting track 531 corresponding to the switching connection section 522 for the switching connection section 522 to move therein. Further, the support rack 53, at two sides of the limiting track 531, comprises a first support portion 532 for holding the first pin 7 and a second support portion 533 for holding the second pin 8. The first support portion 532 has a first slot 534 for embedding the first pin 7. The second support portion 533 has a second slot 535 corresponding to the first slot 534 and for embedding the second pin 8, and an engaging slot 536 for holding the second pin 8. The common pin 6, the first pin 7 and the second pin 8 penetrate through the housing 5 to extend into the accommodating space 51. The common pin 6 is in constant electrical contact with the normal connection section 521 of the conductive elastic plate 52. The first pin 7 comprises a connection section 71 embedded in the first support portion 532, and a contact section 72 extending from the connection section 71 into the limiting track 531. The second pin 8 comprises a trigger section 81 located in the limiting track 531. Between the contact section 72 and the trigger section 81 in the limiting track 531 is free of any object to form an insulation space S1. The housing 5 further comprises a press member 56 assembled with the conductive elastic plate 52, and a restoration spring 57 disposed in the accommodating space 51 and accommodating around the common pin 6 to allow the conductive elastic plate 52 to perform the reciprocating movement. The press member 56 further comprises a flexible support member 561 that is deformed when receiving depression of a user.

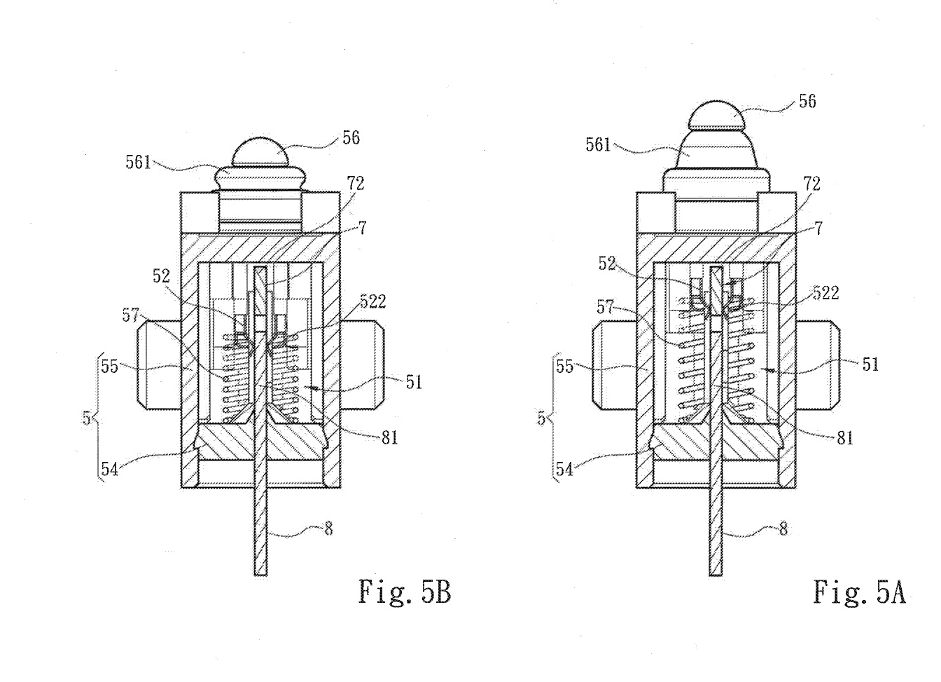

Referring to FIGS. 2 and 5B, in the present invention, the conductive elastic plate 52, when receiving a force of a user, performs a reciprocating movement in the accommodating space 51. In the reciprocating movement, the conductive elastic plate 52 has a released position when being abutted by the restoration spring 57 while not receiving the force, and a pressed position when being pressed. More specifically, the contact section 72 of the first pin 7 and the trigger section 81 of the second pin 8 are respectively on the way of the reciprocating movement of the conductive elastic plate 52. That is to say, when the conductive elastic plate 52 is not pressed by force, the switching connection section 522 is in contact with the contact section 72, such that the common pin 6 and the first pin 7 are set on. When the conductive elastic plate 52 receives force and moves towards the pressed position, the switching connection section 522 disengages from the contact section 72 and passes through the insulation space S1 to in contact with the trigger section 81 of the second pin 8, such that the common pin 6 and the second pin 8 are set on. Thus, carbon residue generated during a switching process of the conductive elastic plate 52 is not accumulated between the contact section 72 and the trigger section 81, thereby enhancing the electrical insulation capability.

In conclusion, the multi-instruction switch for enhancing electrical insulation of the present invention comprises a housing, a common pin and a switching pin set. The housing has an accommodating space, a conductive elastic plate disposed in the accommodating space, and a support rack disposed in the accommodating space and comprising a limiting track. The switching pin set, penetrating through the housing to extend into the accommodating space, comprises a first pin and a second pin disposed on the support rack. The first pin comprises a contact section located in the limiting track. The second pin comprises a trigger section located in the limiting track. The limiting track has an insulation space between the trigger section and the contact section. Thus, carbon residue generated during a switching process of the conductive elastic plate is not accumulated between the contact section and the trigger section, such that the multi-instruction switch of the present invention can be applied to electronic devices having higher amperage.

What is claimed is:

1. A multi-instruction switch for enhancing electrical insulation, comprising:
a housing, including an accommodating space, a conductive elastic plate disposed in the accommodating space and capable of performing a reciprocating movement when receiving depression of a user, and a support rack disposed in the accommodating space, wherein the conductive elastic plate includes a normal connection section and a switching connection section, and wherein the support rack includes a limiting track for the switching connection section to move therein;
a common pin, penetrating through the housing to extend into the accommodating space, normally in electrical contact with the normal connection section; and
a switching pin set, penetrating through the housing to extend into the accommodating space, including a first pin and a second pin disposed on the support rack; the first pin including a contact section located in the limiting track; the second pin including a trigger section located in the limiting track; wherein the limiting track includes an insulation space between the trigger section and the contact section.

2. The multi-instruction switch of claim 1, wherein the support rack comprises a first support portion for holding the first pin, and a second support portion for holding the second pin.

3. The multi-instruction switch of claim 2, wherein the first support portion comprises a first slot for embedding the first pin, and the second support portion comprises a second slot corresponding to the first slot and for embedding the second pin.

4. The multi-instruction switch of claim 2, wherein the second support portion comprises an engaging slot for holding the second pin.

5. The multi-instruction switch of claim 2, wherein the first pin includes a connection section embedded in the first support portion and connected to the contact section.

6. The multi-instruction switch of claim 1, wherein the housing includes a base and a cover.

7. The multi-instruction switch of claim 1, wherein the housing comprises a press member assembled with the conductive elastic plate.

8. The multi-instruction switch of claim 7, wherein the press member comprises a flexible support member that is deformed when receiving the depression of the user during the reciprocating movement.

9. The multi-instruction switch of claim 1, wherein the housing further comprises a restoration spring disposed in the accommodating space and accommodating around the common pin to allow the conductive elastic plate to perform the reciprocating movement.
